(19) United States
(12) Patent Application Publication
(10) Pub. No.: US 2025/0010516 A1
(43) Pub. Date: Jan. 9, 2025

(54) METHOD INTEGRATING ON-SITE MIXING AND CONSTRUCTION FOR PREPARING GREEN AND ULTRA-HIGH-PERFROMANCE CONCRETE

(71) Applicant: Dongmin ZHU, Guiyang (CN)

(72) Inventor: Dongmin ZHU, Guiyang (CN)

(21) Appl. No.: 18/346,739

(22) Filed: Jul. 3, 2023

(51) Int. Cl. B28C 9/00; B28C 7/04

(52) U.S. Cl. CPC B28C 9/002; B28C 7/04

(57) ABSTRACT

A process for preparing green ultra-high-performance concrete involves the preparation of coarse and fine raw materials of engineered sand and stone aggregates in the mechanism sand and stone aggregate production line, and the transportation of high-entropy cementitious powder prepared in the powder production line to the construction site. The process utilizes quantitative packaging or precise measurement on a modular intelligent mixing production line to proportion the ingredients, which are then automatically conveyed to the intelligent mixing equipment for the production of ultra-high-performance concrete or mortar. The concrete is rapidly conveyed to the concrete storage area and immediately poured into the desired shape using seamless pumping, belt conveyance, or bucket lifting methods. This invention effectively improves the processing, transportation, proportioning, and measurement processes of raw materials, enabling integrated on-site batching and construction of concrete.

### CROSS-REFERENCE TO RELATED APPLICATIONS

This application claims priority of China Patent Application No. 202210781028.8, titled “METHOD INTEGRATING ON-SITE MIXING AND CONSTRUCTION FOR PREPARING GREEN AND ULTRA-HIGH-PERFORMANCE CONCRETE,” filed Jul. 4, 2022 in the China National Intellectual Property Administration (CNIPA), the entire contents of which are hereby incorporated by reference in their entireties.

### FIELD OF THE INVENTION

The present invention relates to the field of concrete production, and especially to a method integrating on-site mixing and construction for preparing green and ultra-high-performance concrete.

### BACKGROUND OF THE INVENTION

Concrete is the most widely used construction material and structural engineering material in various human engineering projects. However, existing concrete commonly suffers from issues such as poor durability, significant structural cracking, and insufficient strength.

Currently, there is a widespread issue of “bulky beams, stout columns, and thick piers” in the construction of concrete components, leading to significant waste of resources. Additionally, concrete structures in buildings often suffer from severe cracking, reaching a point where it is commonly said that “no house, bridge, or dam is free from cracks,” which poses a serious threat to the quality and safety of constructions. Moreover, the current practice of pumping precast concrete, in order to address the workability issues within the first two hours, involves the excessive use of various additives. This approach, while attempting to ensure short-term workability, brings hidden defects and risks to the long-term stability and quality of the buildings, thereby severely hindering the sustainable development of concrete.

In conclusion, the current concrete production and pumping processes fail to meet the durability requirements of concrete, as well as the high-quality development and green, low-carbon principles of the construction industry. They fall far short of the national goal of achieving “century-long projects and millennium-long plans” in terms of design requirements. There is an urgent need for technological innovation to develop advanced and environmentally-friendly manufacturing and construction techniques for concrete that offer higher strength and longer lifespan. This will drive the fifth technological revolution in the concrete industry and contribute to the overall goal of achieving sustainable and high-quality development.

An analysis of the reasons behind the current issues with concrete is as follows:

### 1) The Construction Technique of Ready-Mixed Concrete Pumping

Influenced by environmental policies and the increased demand for concrete performance and quantity, the traditional on-site simple mixing approach has been replaced by the advanced technology of ready-mixed concrete pumping. Ready-mixed concrete mixing plants have effectively addressed the environmental and measurement precision issues associated with traditional on-site mixing, thus becoming the primary construction method for concrete nowadays. However, ready-mixed concrete mixing plants are typically constructed in remote outskirts, while urban constructions are situated in city centers. Consequently, after production at the suburban mixing plants, concrete is transported to the construction sites within a 2-hour timeframe using concrete mixing trucks and then pumped to high-rise structures using concrete pump trucks. It is precisely due to this two-hour transportation distance that modern concrete quality encounters new challenges:

(1) Decreased durability of concrete. In order to ensure that concrete is transported to the construction site within 2 hours while maintaining its workability, concrete producers heavily rely on the incorporation of admixtures to extend the concrete's setting time. However, this practice introduces latent defects and hazards, compromising the long-term quality stability of the buildings and sacrificing the longevity of the concrete itself, consequently increasing the production costs of concrete.

(2) Increased transportation costs of concrete. The round-trip transportation costs of concrete mixing trucks are significant. Each time a truck transports concrete, it needs to be thoroughly cleaned, resulting in a tremendous consumption of water resources. Furthermore, almost 5% of the concrete remains unemptied during the discharge process, leading to substantial waste in large-scale pouring sites. Moreover, this process contributes to additional energy consumption and pollution.

### 2) Non-Uniform Concrete Mixture Affecting Strength and Service Life

Concrete, comprising primarily of aggregates (sand and gravel), various powders, water, and different admixtures, is mixed to achieve the desired strength or grade. Traditional methods rely on extending the mixing time to enhance the homogeneity of concrete components. Mechanical mixing, predominantly used in traditional mixing equipment, employs low-speed rotation of mechanical blades to induce convection, vortices, and shear forces among the materials, ensuring thorough blending. However, when it comes to incorporating fine powders, including ultra-fine particles at the nanoscale, mechanical mixing devices encounter a size disparity between the machinery and the aggregates and powders. Consequently, they fail to address the fundamental challenge of powder homogenization. At a microscopic level, powders retain localized individual components, impeding complete chemical reactions and resulting in hidden cracks within the concrete. As a consequence, the concrete's strength potential remains underutilized. Moreover, the non-uniformity in composition contributes to uneven strength distribution in concrete elements, necessitating an increase in the concrete strength coefficient for assurance. This phenomenon leads to the emergence of “bulky beams, stout columns, and thick piers,” resulting in the wastage of substantial non-renewable resources.

### 3) Instability in the Gradation of Sand and Gravel Aggregates

Mechanically crushed sand and gravel aggregates constitute the primary components of concrete, accounting for over 75-85% of its composition. The quality of these aggregates plays a crucial role in determining concrete's overall quality. These aggregates exhibit significant variations in particle size, ranging from millimeters to micrometers. During the storage and transportation of sand and gravel aggregates, inevitable phenomena of segregation occur. Segregation leads to the accumulation of finer particles in the central region while coarser aggregates settle towards the periphery. In the process of material extraction, it is common practice to take materials from the outer regions towards the inner regions. Consequently, the initial batches of mixing utilize coarser aggregates, while subsequent batches employ finer aggregates. This severe inconsistency greatly impacts the quality of the concrete. As a result, each batch of mechanically crushed sand and gravel aggregates possesses a unique gradation, rendering it impossible to achieve precise control over the raw materials in concrete production, thus undermining the accurate measurement capabilities of the mixing plant.

### (4) Disconnection Between Sand and Gravel Aggregate Production and Concrete Material Flow Management

There exists a lack of synchronization between the production of sand and gravel aggregates and the material flow management in concrete production, which to some extent compromises the quality of concrete raw materials. Sand and gravel aggregate production companies focus on controlling the production quality of these aggregates, while concrete mixing plants prioritize measurement accuracy. Unfortunately, the intermediate processes of storage, transportation, and handling lack necessary quality control measures. This disjointed approach contributes to the deterioration of concrete quality, serving as one of the reasons for its inferior performance.

As society continues to advance, there is an increasing demand in the market for high-quality concrete. Therefore, the development of a method for preparing a green ultra-high-performance concrete, encompassing both on-site mixing and construction, is an urgent technological challenge that needs to be addressed.

### SUMMARY OF THE INVENTION

Given these circumstances, the objective of this invention is to provide a method for preparing green ultra-high-performance concrete. The method combines on-site mixing and construction, thereby overcoming the shortcomings of existing technologies.

A method for preparing a green and ultra-high-performance concrete is provided. The method includes:
(1) preparing aggregate raw materials in an aggregate production line;
(2) preparing a powder materials of high-entropy powdered cementitious in a powder production line;
(3) providing a mixing production line, which is modular, at a construction site, wherein the aggregate raw materials and the powder materials of high-entropy powdered cementitious are measured and proportioned using quantitative packaging or direct measurement on the mixing production line; wherein the aggregate raw materials and the powder materials are then automatically conveyed to a mixing equipment to produce the ultra-high-performance concrete or mortar;
(4) conveying the ultra-high-performance concrete to a concrete storage area for immediately pouring using seamless pumping, belt conveyance, or bucket lifting methods.

In some embodiments, the powdered cementitious is premixed for preparing the powder materials, and then the aggregate raw materials are mixed with the powder materials for manufacturing the ultra-high-performance concrete.

In some embodiments, in the powder production line for the powdered cementitious, pretreating the powder cementitious in a uniform dry mixing; quantitatively packaging and transporting the pretreated powder cementitious to the construction site; adding and mixing water to the pretreated powder cementitious uniformly to form a mixed slurry; and mixing the aggregate raw materials and the mixed slurry to produce the ultra-high-performance concrete or mortar.

In some embodiments, the powdered cementitious are precisely measured and proportioned in the mixing production line, and conveyed to powder mixing equipment for high-speed mixing to obtain the mixing slurry; the mixing slurry is mixed with the aggregate raw materials precisely proportioned and measured on site to manufacture the ultra-high-performance concrete or mortar.

In some embodiments, the aggregate raw materials from the aggregate production line are packaged into aggregate packs according to a concrete formula requirements and batching station dosage demands; the powder materials from the powder production line are packaged into dry powder packs according to the concrete formula requirements and batching station dosage demands, both of which require at least one package per batch for mixing.

In some embodiments, the aggregate raw materials and the powder materials are packaged into mixed dry material packs according to the concrete formula requirements and batching station dosage demands; wherein at least one packages per batch is used for mixing.

In some embodiments, the material conveying and proportioning system is installed in a modular and automatic form to measuring the aggregate raw materials and the powder materials on sit.

In some embodiments, the aggregate raw materials obtained from the aggregate production line and the powder materials obtained from the powder production line are conveyed and proportioned directly the material conveying and proportioning system.

The material conveying and proportioning system comprises an aggregate conveying and proportioning system for the measurement and transportation of the aggregate raw materials, and a powder conveying and proportioning system for the measurement and transportation of the powder materials; the aggregate conveying and proportioning system and the powder conveying and proportioning system are assembled in a form of tower or flat configuration according to the pouring site.

In some embodiments, a wastewater treatment system is mounted on the bottom of the mixing equipment for treating a cleaning water of the mixing equipment; a recycle water is capable of being reused for the preparation of the concrete.

In some embodiments, the material flow utilizes 5G signal transmission technology, and the entire process of material handling is equipped with information digitized monitoring and real-time digital detection and verification of concrete quality.

Compared to the existing technology, the present invention discloses an integrated process for on-site batching and construction of green (ultra) high-performance concrete. It involves the preparation of coarse and fine raw materials of engineered sand and stone aggregates in the mechanism sand and stone aggregate production line and the transportation of high-entropy cementitious powder prepared in the powder production line to a modular intelligent mixing production line set up at the construction site. The process utilizes quantitative packaging or precise measurement of ingredients or raw materials on the modular intelligent mixing production line, which are then automatically conveyed to the intelligent mixing equipment for the production of (ultra) high-performance concrete or mortar. The (ultra) high-performance concrete or mortar is swiftly conveyed to the concrete storage area and immediately poured into shape using seamless pumping, belt conveyance, or bucket lifting methods.

Notably, during the preparation of high-entropy cementitious powder in the powder production line, a dry mixing process is employed to ensure the homogeneity of the cementitious powder. This guarantees thorough and uniform mixing during the subsequent preparation of concrete, thus achieving (ultra) high-performance concrete. Furthermore, the use of a modular intelligent mixing production line at the construction site enables precise measurement of ingredients and allows for direct and rapid conveyance of concrete or mortar to the concrete storage area for immediate pouring. This effectively solves issues associated with the existing precast method, such as high cost due to the need for transit through mixing trucks, slump loss, performance degradation, and high energy consumption.

The present invention effectively enhances the processing, transportation, proportioning, and metering processes of raw materials, thereby achieving the integration of on-site mixing and construction of concrete. The specific beneficial effects are as follows:

(1) Precise preprocessing of powder: By subjecting the powder to preprocessing, it ensures thorough and uniform mixing, guaranteeing the homogeneity of the concrete. This avoids the deficiencies caused by uneven mixing of the powder, such as a single chemical composition and insufficient reaction, greatly enhancing the strength of the concrete.

(2) On-site precise proportioning and metering: During the on-site mixing process, the use of on-site precise proportioning and metering or quantification packaging techniques enables accurate proportioning and metering. This improves the stability of the concrete and allows for the production of green (ultra) high-performance concrete, addressing the issues of high carbon content, low quality, and short lifespan associated with traditional concrete preparation and construction methods. It also provides a viable solution for the carbon, personnel, and height limitations in the concrete industry.

(3) Modular sealed configuration: In the on-site precise proportioning and metering or quantification packaging process, a modular sealed configuration is employed, minimizing the risk of leaks and reducing dust emissions. This results in lower dust collection costs and contributes to an environmentally friendly approach.

(4) Optimization of concrete formulation: The present invention optimizes the formulation of concrete, effectively reducing pollution and energy consumption in the concrete industry. Firstly, while ensuring the performance of the concrete, it significantly reduces the amount of cement used. Compared to traditional processes, cement consumption can be reduced by 50%, thereby lowering carbon emissions. Secondly, it reduces the cost associated with mixer truck operations. The produced mixed soil can be immediately transported and poured, eliminating the need for various additives to maintain workability over a period of 2 hours. This ensures that the concrete remains intact without slump wastage, reducing the need for excessive additives to maintain its fluidity. Additionally, it saves labor and resources required for mixer truck cleaning, thus reducing water consumption in the concrete industry.

(5) Enhancement of concrete stability: By eliminating various uncontrollable factors that deteriorate concrete quality in traditional manufacturing processes, the present invention ensures improved stability of the concrete.

The other advantages, objectives, and features of the present invention will be elucidated to some extent in the subsequent description, and to some extent, they will be evident to those skilled in the art based on a thorough examination and research of the following disclosure or can be derived from the practice of the invention. The objectives and other advantages of the present invention can be achieved and obtained through the following description.

### BRIEF DESCRIPTION OF THE DRAWINGS

To elucidate the objectives, technical solutions, and advantages of the present invention more clearly, a detailed description will be provided below in conjunction with the accompanying drawings.

FIG. 1 is a first flow schematic diagram of a method for preparing a green and ultra-high-performance concrete according to the present invention.

FIG. 2 is a second flow schematic diagram of the method for preparing a green and ultra-high-performance concrete according to the present invention.

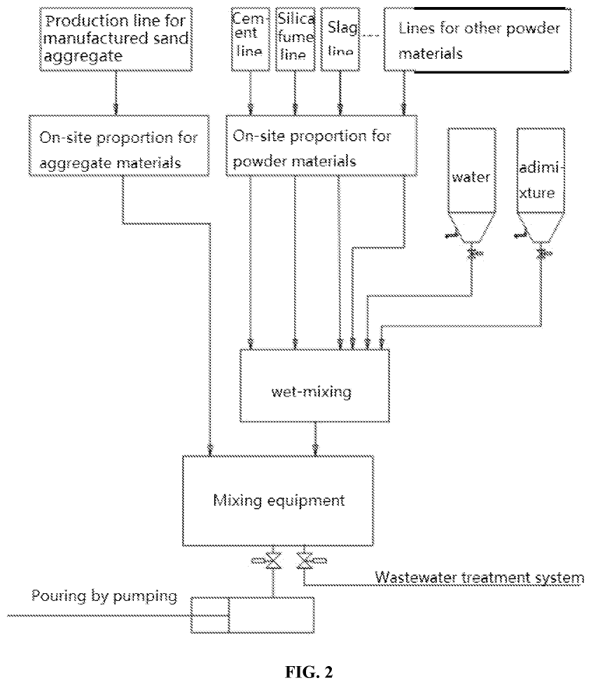

FIG. 3 is a third flow schematic diagram of the method for preparing a green and ultra-high-performance concrete according to the present invention.

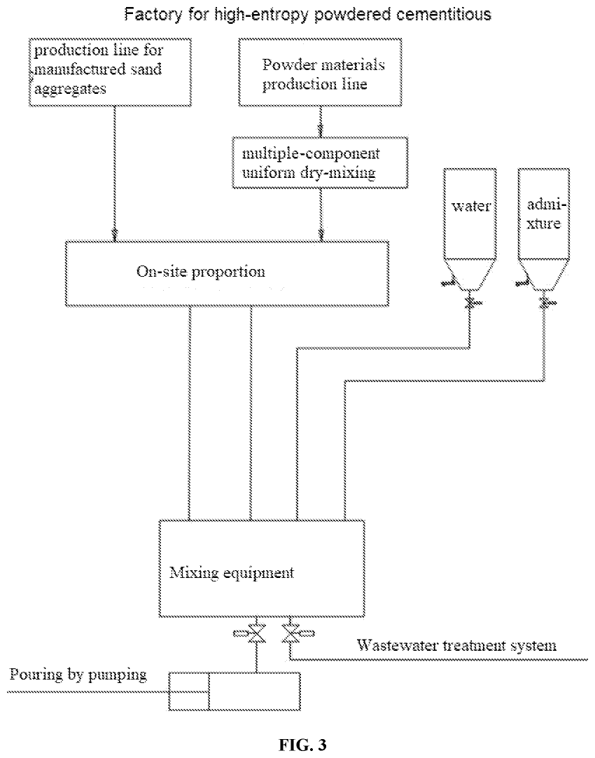

FIG. 4 is a fourth flow schematic diagram of the method for preparing a green and ultra-high-performance concrete according to the present invention.

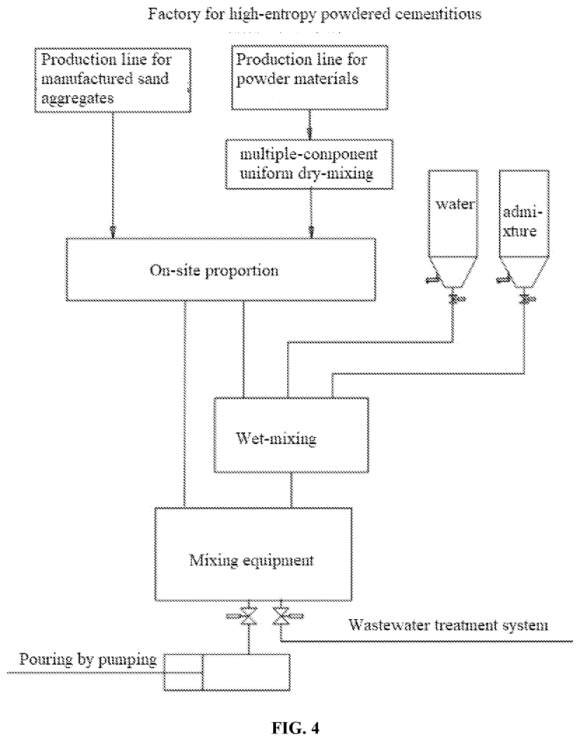

FIG. 5 is a fifth flow schematic diagram of the method for preparing a green and ultra-high-performance concrete according to the present invention.

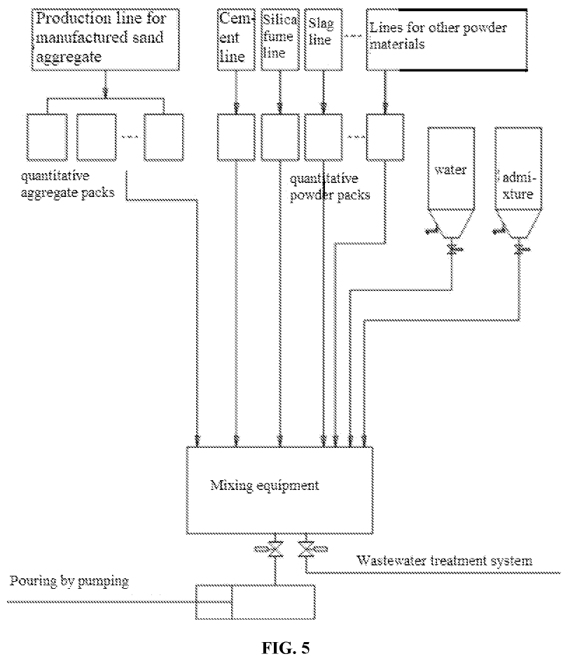

FIG. 6 is a sixth flow schematic diagram of the method for preparing a green and ultra-high-performance concrete according to the present invention.

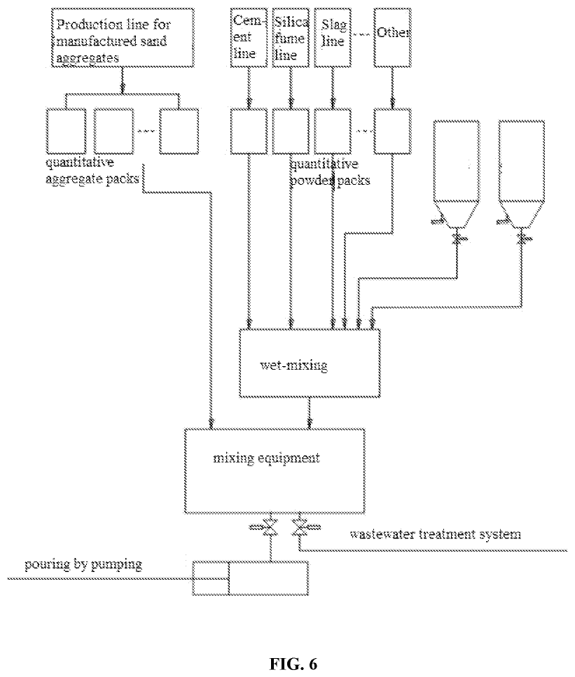

FIG. 7 is a seventh flow schematic diagram of the method for preparing a green and ultra-high-performance concrete according to the present invention.

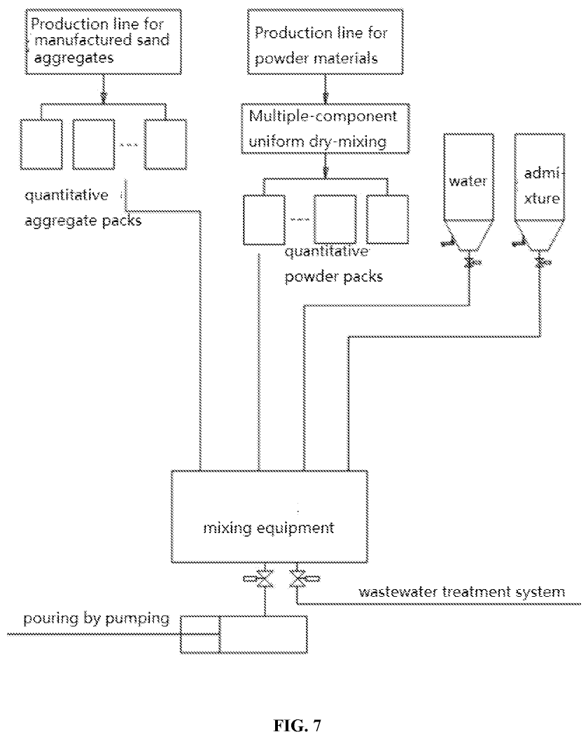

FIG. 8 is an eighth flow schematic diagram of the method for preparing a green and ultra-high-performance concrete according to the present invention.

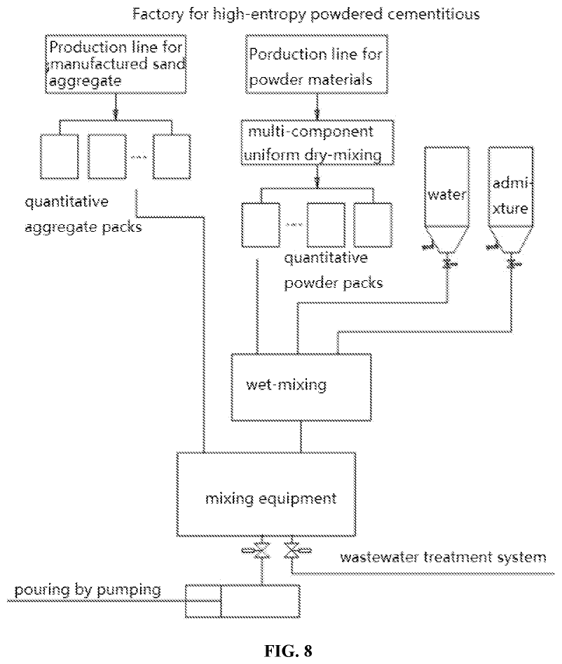

### DETAILED DESCRIPTION OF THE INVENTION

The following detailed description will refer to the accompanying drawings and present the preferred embodiments of the present invention. It should be understood that these embodiments are provided for illustrative purposes only and do not limit the scope of the invention.

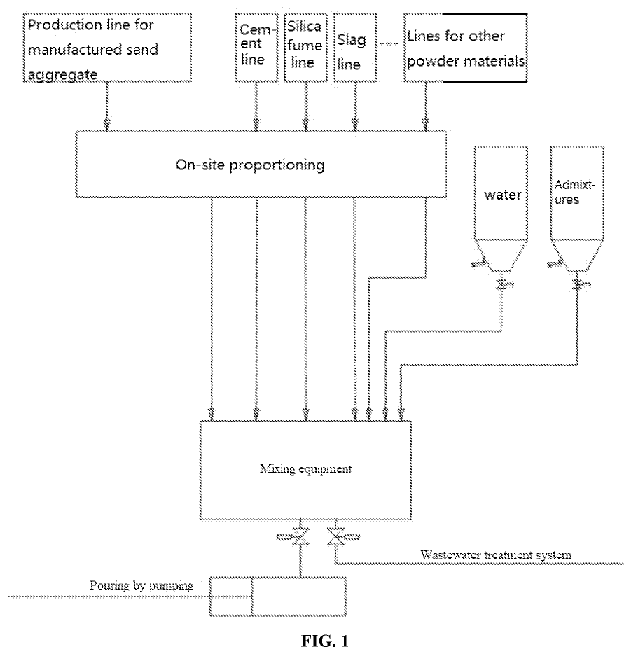

Referring to FIG. 1 to FIG. A method for preparing a green and ultra-high-performance concrete is provided. The method includes the following steps.

(1) Preparing aggregate raw materials in an aggregate production line.

(2) Preparing a powder materials of high-entropy powdered cementitious in a powder production line.

(3) Providing a mixing production line, which is modular, at a construction site, wherein the aggregate raw materials and the powder materials of high-entropy powdered cementitious are measured and proportioned using quantitative packaging or direct measurement on the mixing production line; wherein the aggregate raw materials and the powder materials are then automatically conveyed to a mixing equipment to produce the ultra-high-performance concrete or mortar.

(4) Conveying the ultra-high-performance concrete to a concrete storage area for immediately pouring using seamless pumping, belt conveyance, or bucket lifting methods.

In steps (1) and (2), the aggregate raw materials produced by the aggregate production line can be transported to the construction site through bulk transportation, modular packaging transportation, or quantitative packaging transportation. For materials transported in bulk or in bulk packaging, they can be precisely measured on-site and conveyed to an intelligent mixing equipment. As for materials in quantitative packaging, they can be added to the intelligent mixing equipment in at least one package per batch.

The powder materials produced by the powder production line can be transported to the construction site through bulk transportation, modular packaging transportation, or quantitative packaging transportation. The modular packaging transportation or quantitative packaging can be done through separate measurement packaging or mixed packaging after measurement. For materials transported in bulk or in bulk packaging, they can be precisely measured on-site and conveyed to the intelligent mixing equipment. As for materials in quantitative packaging, they can be added to the intelligent mixing equipment in at least one package per batch.

In step (2), the powdered cementitious is initially subjected to high-entropy homogeneous mixing to prepare high-entropy powdered raw material, which is then mixed at low speed with the aggregates to produce the ultra-high-performance concrete or mortar.

Preferably, the high-entropy cementitious powder is prepared by dry mixing and uniformly packaged in the production line. It is then transported to the construction site where water is added to achieve high-entropy homogeneous mixing and form a mixed slurry. Subsequently, the slurry is mixed with the aggregates (sand and gravel) to manufacture ultra-high-performance concrete or mortar. The high-entropy cementitious powder production line mentioned here refers to a powder production facility that produces concrete powder raw materials, performs measurement, and conducts high-entropy mixing.

Furthermore, it is possible to employ on-site precision control and measurement processes for raw material batching. Specifically, the high-entropy cementitious powder, when supplied in bulk, undergoes precise metering and batching in a modular intelligent mixing production line. The material is then conveyed automatically to the high-speed mixing equipment for thorough and homogeneous blending, resulting in a mixed slurry. Subsequently, this slurry is mixed with on-site precision-metered sand and gravel aggregates to produce (ultra) high-performance concrete or mortar.

In a preferred embodiment, a modular assembly of an automated material conveying and proportioning system is installed at the construction site. This system enables precise on-site metering of the aggregates and powdered materials. Specifically, the automated material conveying and proportioning system is designed with a modular assembly, facilitating easy transportation and hoisting. It can be quickly assembled on-site using lifting equipment for immediate utilization.

Even more preferably, the modular assembly of the automated material conveying and proportioning system is used for the direct modular transportation and proportioning of the manufactured sand and gravel aggregates from the production line and the concrete powder materials from the powder production line. Specifically, the sand and gravel aggregates produced in the sand and gravel production line, as well as the concrete powder materials produced in the powder production line, are directly loaded into the automated material conveying and proportioning system. They are then transported in a modular manner to the construction site, where they undergo precise on-site metering and are conveyed to the intelligent mixing equipment for the production of (ultra) high-performance concrete or mortar. This approach effectively addresses the dust-related issues during transportation and on-site preparation, ensuring environmental friendliness and high production efficiency.

Even more preferably, the containerized automated material conveying and proportioning system includes an aggregate conveying and proportioning system for the transportation and metering of the manufactured sand and gravel aggregates, as well as a powder conveying and proportioning system for the transportation and metering of the powder materials. These systems can be assembled in a vertical station or laid out in a flat configuration based on the pouring site requirements. Specifically, the aggregate conveying and proportioning system and the powder conveying and proportioning system can be arranged according to the scale of the construction site. For larger construction sites, a flat configuration can be employed, where the aggregate conveying and proportioning system and the powder conveying and proportioning system are separately placed on the site and connected to the intelligent mixing equipment. For narrower construction sites, a vertical station assembly can be utilized, where the aggregate conveying and proportioning system and the powder conveying and proportioning system are stacked in a modular structure. The aggregate conveying and proportioning system and the powder conveying and proportioning system can be positioned on any completed building floor, either on the same floor or on different floors.

Alternatively, the modular quantitative packaging process can be employed for direct material placement. Specifically, in the sand and gravel aggregate production line, the manufactured sand and gravel aggregates can be packaged into aggregate bags according to the concrete formulation requirements and the batch dosage requirements of the mixing station. In the powder production line, the concrete powder materials can be packaged into dry powder bags during the production process according to the concrete formulation requirements and the batch dosage requirements of the mixing station. Both the aggregate bags and the dry powder bags can be used for mixing in quantities of at least one bag per batch.

It is preferred to use an integrated sand and gravel aggregate production line and powder production line to package the manufactured sand and gravel aggregates and powder materials into mixed dry packs according to the concrete formulation requirements and the batch dosage requirements of the mixing station. The mixed dry packs are then used for mixing in quantities of at least one pack per batch. This integrated approach facilitates management and transportation, reduces transportation costs, and improves production efficiency.

A wastewater treatment system is integrated at the bottom of the mixing equipment to treat the water used for mixing and cleaning the construction equipment. The treated water can be recycled and used again for preparing concrete or mortar. This recycling of wastewater promotes energy conservation and environmental sustainability.

In the aforementioned integrated process, the material flow can be transmitted using 5G signal technology, and the entire process is digitally monitored and controlled, with online digital detection and verification of concrete quality. This enables automated and intelligent production.

The aggregate production line for preparing manufactured sand and gravel aggregates includes mechanism fine aggregates with a particle size of 0-5 mm, mechanism mica stones with a particle size of 5-10 mm, and mechanism crushed stones with a particle size of 10-20 mm.

The powder production line prepares cement powder, ordinary stone powder, ultrafine stone powder, and mineral admixtures. The mineral admixtures can include two or more of coal ash, mineral powder, silica fume, and microspheres. The dry mixing process is used to homogeneously mix and prepare the powder materials for high-entropy cementitious powder.

Compared to conventional on-site mixing processes, the present invention effectively improves the handling, transportation, proportioning, and metering of raw materials. Firstly, it ensures thorough and uniform mixing of the powder materials, guaranteeing the homogeneity of the concrete and avoiding deficiencies such as uneven chemical composition and incomplete reactions caused by uneven powder mixing. This improves the strength of the concrete. Secondly, it enables precise proportioning and metering, enhancing the stability of the concrete. Lastly, it promotes green and environmentally friendly practices by effectively preventing dust generation during raw material transportation and concrete preparation.

Compared to conventional precast processes, the present invention allows the concrete or mortar to be transported and poured immediately onto the concrete surface in the shortest possible time. This effectively solves the problems associated with high costs, slump loss, and performance degradation caused by the need for intermediate mixing truck transfers in existing precast methods. It also reduces energy consumption.

The raw material information used in Examples 1-5 includes: Conch brand 425-grade cement, Mingchuan Grade II fly ash, Haotong S95-grade mineral powder, self-made polycarboxylate superplasticizer (solid content: 12%), mechanism medium sand, and mechanism 5-25 mm crushed stone.

In this baseline experiment, the traditional precast pumping process with a C30 mix design was used. The slump value was 220±20 mm, the slump retention time was 2 hours, and the slump loss was less than 20 mm. The spread diameter was 550±20 mm.

Example 1, preparing concrete by traditional formula and methods

| Raw | | Coal | | Manufactured | Manufactured | | |
|---|---|---|---|---|---|---|---|
| materials | Cement | ash | Slag | sand | gravel | Admixtures | Water |
| Use | 240 | 50 | 50 | 900 | 1000 | 6 | 165 |
| (kg/m²) | | | | | | | |

Taking the production of 1 m3 of concrete as an example, according to the traditional concrete production process, the aggregates and powder are transferred from the storage silos to the mixing plant. Through the material proportioning and measuring system, the aggregates and powder are separately fed into the mixing equipment in the proper proportions. After adding admixtures and water, the concrete is mixed and produced.

Example 2 adopts the traditional formula and combines on-site precise proportioning, measuring, and powder pre-mixing process for concrete preparation.

Aggregates are stored in containerized form, and dry powder is packed proportionally according to the grade. Taking C30 concrete as an example,

| Raw | | Coal | | Manufactured | Manufactured | | |
|---|---|---|---|---|---|---|---|
| materials | Cement | ash | Slag | sand | gravel | Admixtures | Water |
| Use | 240 | 50 | 50 | 900 | 1000 | 5 | 165 |
| (kg/m²) | | | | | | | |

The aggregates and dry-mixed powder are transferred from the storage silos to the mixing station. Firstly, the dry powder is proportionally mixed with water to obtain a slurry using the material proportioning and measuring system. Then, the aggregates and slurry are proportionally fed into the mixing equipment. After adding admixtures and water, the mixture is stirred to produce concrete. This experiment uses the same formula as Example 1 to verify the improvement in concrete performance using the process described in Example 2 under the same conditions and with the same raw materials.

Since this invention is suitable for on-site application, the requirement for slump performance of traditional precast pumpable concrete is not very high. Therefore, achieving the workability performance of slump 220±20 mm, setting time 2 hours, slump loss <20 mm, and spread diameter φ550±20 mm can be accomplished with a reduced dosage of admixtures.

In Example 3, the traditional formula is used in combination with the modular packaging process for raw materials and the dry powder pre-mixing process for concrete preparation.

The aggregates are packaged as a whole according to a certain ratio, and the dry powder, which has been dry mixed according to the specifications, is packaged proportionally. Taking C30 concrete as an example, the process is as follows:

| Raw | | Coal | | Manufactured | Manufactured | | |
|---|---|---|---|---|---|---|---|
| materials | Cement | ash | Slag | sand | gravel | Admixtures | Water |
| Use | 240 | 50 | 50 | 900 | 1000 | 4.5 | 165 |
| (kg/m²) | | | | | | | |

In Example 3, the aggregates are processed into aggregate packages at the aggregate production station, and the dry powder, which has been dry mixed, is processed into powder packages at the powder production station. These packages are then added to the mixing equipment, along with the admixture and water, using a mixing ratio of 1 package per batch. After mixing, the resulting mixture is used to produce concrete. The same formula as Example 1 is used in this experiment to demonstrate the improved performance of concrete using the process described in Example 3, under the same conditions and with equivalent raw materials.

Since the present invention is suitable for on-site applications, the requirements for workability in traditional precast and pumped concrete are not very high. Therefore, achieving the specified slump of 220±20 mm, a slump retention time of 2 hours, a slump loss of less than 20 mm, and an expansion of ±550±20 mm can be achieved with a reduced dosage of admixture.

Example 4 adopts the identical production method to Example 2, while the formular in Example 4 is changed so as to reach the results of Example 1.

| Raw | | Coal | | Manufactured | Manufactured | | |
|---|---|---|---|---|---|---|---|
| materials | Cement | ash | Slag | sand | gravel | Admixtures | Water |
| Use | 190 | 60 | 60 | 880 | 1050 | 4.5 | 160 |
| (kg/m²) | | | | | | | |

By employing the same production process as demonstrated in Example 2, and through the optimization of the formulation, we were able to achieve concrete products that exhibit mechanical performance results comparable to those detected in Example 1. Furthermore, a cost savings analysis was conducted.

Example 5 adopts the identical production method to Example 3, while the formular in Example 5 is changed so as to reach the results of Example 1.

| Raw | | Coal | | Manufactured | Manufactured | | |
|---|---|---|---|---|---|---|---|
| materials | Cement | ash | Slag | sand | gravel | Admixtures | Water |
| Use | 160 | 50 | 50 | 880 | 1050 | 4 | 150 |
| (kg/m²) | | | | | | | |

Utilizing the identical production methodology as demonstrated in Example 3, by optimizing the formulation, we have achieved a product that exhibits mechanical performance comparable to the tested results of Example 1. Furthermore, we shall analyze the cost-saving ratio.

### Experimental Testing

1. The mechanical performance of the concrete was tested according to the standard GB/T50081-2019 “Standard Test Methods for Mechanical Properties of Concrete.”

2. The experimental test results for the mechanical performance of the concrete in Examples 1-5, along with the cost-saving analysis, are presented in the table below:

| Detection item | Exam. 1 | Exam. 2 | Exam. 3 | Exam. 4 | Exam. 5 |
|---|---|---|---|---|---|
| Compressive strength | 33.1 | 38.9 | 41.2 | 34.1 | 33.5 |
| Cement savings | / | / | / | 20.80% | 33.30% |
| Strength increase | / | 17.52% | 24.47% | 3.02% | 1.21% |
| Impermeability index | P6 | P8 | P10 | P8 | P8 |

From the experimental results in the table, it can be observed that:

The mechanical properties of the concrete prepared in Examples 2-5 still meet the requirements for use. In Examples 2-3, the mechanical performance of the concrete shows significant improvement, with a strength increase of more than 15%. In Examples 4-5, while ensuring comparable mechanical properties to Example 1, there is a cement savings of over 20%, resulting in a significant reduction in the economic cost of the concrete.

The impermeability performance has been improved from the ordinary P6 level to P8 or higher.

Based on the above, the integrated process described in this invention offers several benefits. Firstly, it enhances the homogeneity of the concrete slurry components, resulting in a more uniform flowability and homogeneity of the concrete product. Secondly, through the integrated on-site mixing and casting process, combined with accurate on-site proportioning or quantified packaging of raw materials, it addresses the issues of measurement errors and quality deviations commonly encountered in traditional commercial concrete plants. As a result, the manufactured concrete products exhibit significant improvements in various performance aspects, while achieving substantial energy cost savings.

The above description is merely the preferred embodiment of the present invention and should not be construed as limiting the invention in any way. Any simple modifications, equivalent variations, or refinements made to the above embodiments, based on the technical essence of the present invention, are still within the scope of the invention.

1. A method for preparing a green and ultra-high-performance concrete, comprising:
(1) preparing aggregate raw materials in an aggregate production line;
(2) preparing a powder materials of high-entropy powdered cementitious in a powder production line;
(3) providing a mixing production line, which is modular, at a construction site, wherein the aggregate raw materials and the powder materials of high-entropy powdered cementitious are measured and proportioned using quantitative packaging or direct measurement on the mixing production line; wherein the aggregate raw materials and the powder materials are then automatically conveyed to a mixing equipment to produce the ultra-high-performance concrete or mortar;
(4) conveying the ultra-high-performance concrete to a concrete storage area for immediately pouring using seamless pumping, belt conveyance, or bucket lifting methods.

2. The method according to claim 1, wherein the powdered cementitious is premixed for preparing the powder materials, and then the aggregate raw materials are mixed with the powder materials for manufacturing the ultra-high-performance concrete.

3. The method according to claim 2, wherein in the powder production line for the powdered cementitious, pretreating the powder cementitious in a uniform dry mixing; quantitatively packaging and transporting the pretreated powder cementitious to the construction site; adding and mixing water to the pretreated powder cementitious uniformly to form a mixed slurry; and mixing the aggregate raw materials and the mixed slurry to produce the ultra-high-performance concrete or mortar.

4. The method according to claim 2, wherein the powdered cementitious are precisely measured and proportioned in the mixing production line, and conveyed to powder mixing equipment for high-speed mixing to obtain the mixing slurry; the mixing slurry is mixed with the aggregate raw materials precisely proportioned and measured on site to manufacture the ultra-high-performance concrete or mortar.

5. The method according to claim 3, wherein the aggregate raw materials from the aggregate production line are packaged into aggregate packs according to a concrete formula requirements and batching station dosage demands; the powder materials from the powder production line are packaged into dry powder packs according to the concrete formula requirements and batching station dosage demands, both of which require at least one package per batch for mixing.

6. The method according to claim 2, wherein the aggregate raw materials and the powder materials are packaged into mixed dry material packs according to the concrete formula requirements and batching station dosage demands; wherein at least one packages per batch is used for mixing.

7. The method according to claim 2, wherein the material conveying and proportioning system is installed in a modular and automatic form to measuring the aggregate raw materials and the powder materials on sit.

8. The method according to claim 6, wherein the aggregate raw materials obtained from the aggregate production line and the powder materials obtained from the powder production line are conveyed and proportioned directly the material conveying and proportioning system;
Wherein the material conveying and proportioning system comprises an aggregate conveying and proportioning system for the measurement and transportation of the aggregate raw materials, and a powder conveying and proportioning system for the measurement and transportation of the powder materials; the aggregate conveying and proportioning system and the powder conveying and proportioning system are assembled in a form of tower or flat configuration according to the pouring site.

9. The method according to claim 1, wherein a wastewater treatment system is mounted on the bottom of the mixing equipment for treating a cleaning water of the mixing equipment; a recycle water is capable of being reused for the preparation of the concrete.

10. The method according to claim 1, wherein the material flow utilizes 5G signal transmission technology, and the entire process of material handling is equipped with information digitized monitoring and real-time digital detection and verification of concrete quality.
